(19) United States
(12) Patent Application Publication
(10) Pub. No.: US 2008/0064387 A1
(43) Pub. Date: Mar. 13, 2008

(54) APPARATUS AND METHOD FOR AUTOMATICALLY ENABLING CELL PHONE RINGING OR BEEPING

(76) Inventor: Lawrence J. Koncelik, East Hampton, NY (US)

Correspondence Address: WALTER J. TENCZA JR., 100 Menlo Park, Suite 210, Edison, NJ, 08837, US

(21) Appl. No.: 11/309,658

(22) Filed: Sep. 7, 2006

(51) Int. Cl. H04Q 7/20

(52) U.S. Cl. 455/425

(57) ABSTRACT

A cellular telephone is disclosed including a device for placing the cellular telephone in an off state or an on state. The cellular telephone may include a processor, and a receiver. The processor may be programmed to change the cellular telephone from the off state to the on state in response to a remote control signal received by the receiver. In another embodiment, the cellular telephone may include a device for placing the cellular telephone in a silent state or an audible state. The processor may be programmed to change the cellular telephone from the silent state to the audible state in response to a remote control signal received by the receiver.

### FIELD OF THE INVENTION

This invention relates to improved methods and apparatus concerning cellular telephone (cell phone) related devices.

### BACKGROUND OF THE INVENTION

There are various devices known in the prior art related to cell phones or cellular telephones. U.S. Pat. No. 6,573,832 to Fugere-Ramirez discloses a remote finder for finding lost personal items, such as keys, a pager, a cellular phone, etc. (Fugere-Ramirez, col. 3, Ins. 53-60). A receiver is attached to a personal item by a sticker. (Id.) The remote control finder sends a radio signal to the receiver, and the receiver emits an audible beeping noise. (Id.) U.S. Pat. No. 6,970,724 to Leung provides an apparatus and method for selectively disabling audible cell phone ringing. (Leung, col. 2, Ins. 59-64). A cell phone may be programmed to respond to a radio frequency signal by switching from an audible mode of operation to a silent mode of operation. (Leung, col. 3, Ins. 15-32).

### SUMMARY OF THE INVENTION

One embodiment of the present invention provides an apparatus and method for remotely enabling cell phone ringing or beeping when the cell phone was last left in its turned off state. A person who can not locate his or her cell phone (first telephone), first dials his/her cell phone number from a second telephone and then enters a pass code into the second telephone. This causes the lost cell phone to be turned on remotely and then to ring or beep so that the cell phone can be located. Another embodiment would cause the cell phone to beep or ring even if the cell phone is turned off and even if the cell phone is set to a non audible mode such as silent or vibrate.

In one embodiment, a radio frequency transmitter is used to transmit a radio frequency (RF) control signal. Upon receiving the control signal, the cell phone is turned on so that it will ring or beep. The cell phone can be programmed so that when it is turned on this way it will revert to its audible ringing or beeping mode rather than remain in a silent or vibrate mode. In another embodiment of the present invention, an RF signal that causes a cell phone to ring or beep, without turning on the cell phone first, may be provided.

In one embodiment, the present invention provides an apparatus comprising a cellular telephone. The cellular telephone may include a device for placing the cellular telephone in an off state or an on state. In the off state the cellular telephone typically cannot receive a telephone call, and in the on state the cellular telephone can receive a telephone call. The apparatus may include a processor, and a receiver. The processor may be programmed to change the cellular telephone from the off state to the on state in response to a remote control signal received by the receiver.

In another embodiment, the cellular telephone may include a device for placing the cellular telephone in a silent state or an audible state. In the silent state, the cellular telephone responds to a telephone call with an alert that is not audible, and in the audible state the cellular telephone responds to a telephone call with an alert that is audible. The processor may be programmed to change the cellular telephone from the silent state to the audible state in response to a remote control signal received by the receiver.

The processor may be programmed to examine the remote control signal, such that the remote control signal must include a specific pass code in order for the processor to change the cellular telephone from the off state to the on state or from the silent state to the audible state.

### BRIEF DESCRIPTION OF THE DRAWINGS

FIG. 1 shows a flow chart of a method in accordance with an embodiment of the present invention;

FIG. 2 shows a diagram of a system or apparatus in accordance with an embodiment of the present invention;

FIG. 3 shows a simplified diagram of external features of a cell phone for use with the system and method of FIGS. 1 and 2; and

FIG. 4 shows a diagram of internal components of the cell phone of FIG. 3.

### DETAILED DESCRIPTION OF THE DRAWINGS

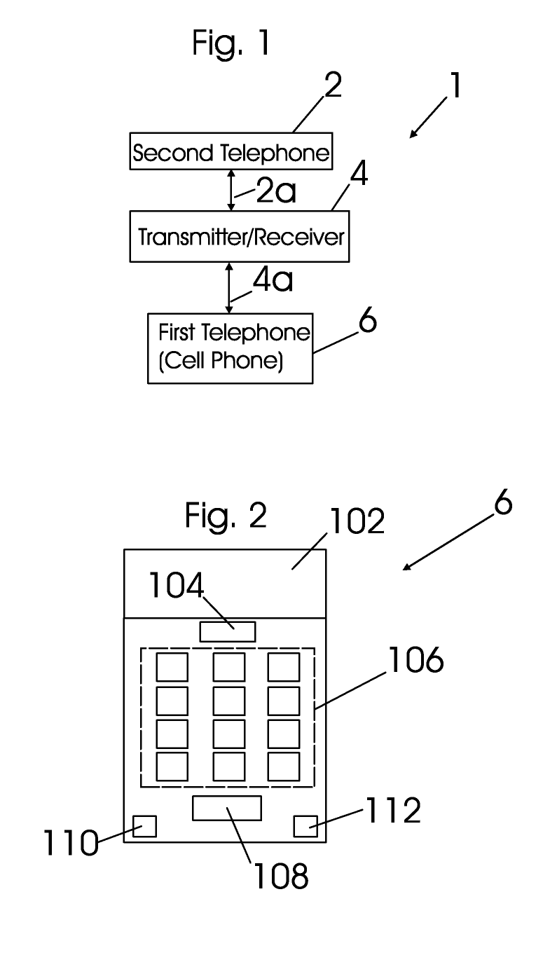

FIG. 1 shows a diagram of a system or apparatus 1 in accordance with an embodiment of the present invention. The apparatus 1 includes a second telephone 2, a transmitter/receiver 4, and a first (cellular) telephone 6. The second telephone 2 communicates with the transmitter/receiver 4 via a communications link 2a. The transmitter/receiver 4 communicates with the first (cellular) telephone via a communications link 4a.

FIG. 2 shows a simplified diagram of external features of cellular or cell phone 6. The cell phone 6 includes a video display or monitor 102, a speaker 104, a keypad 106, a microphone 108, an on/off switch 110, and a vibrate or silent mode switch 112.

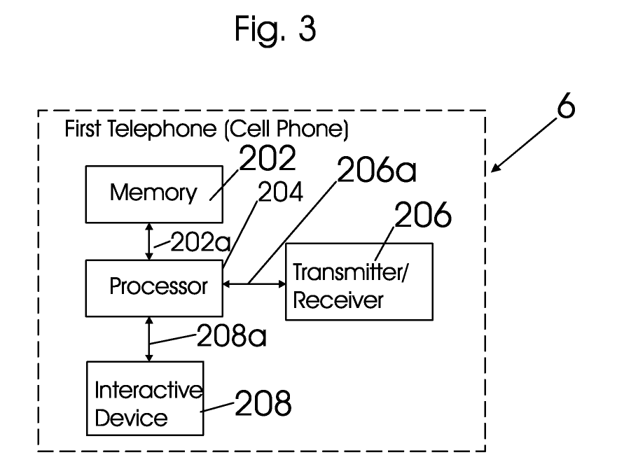

FIG. 3 shows a diagram of internal components of the cell phone of 6. The cell phone 6 includes a processor 204, a memory 202, a transmitter/receiver 206, and an interactive device 208. The processor 204 may be a computer processor. The memory 202 may be computer memory. The interactive device 208 may include a keypad including keypad 106 in FIG. 3, and any other interactive device such as a computer mouse or stylus.

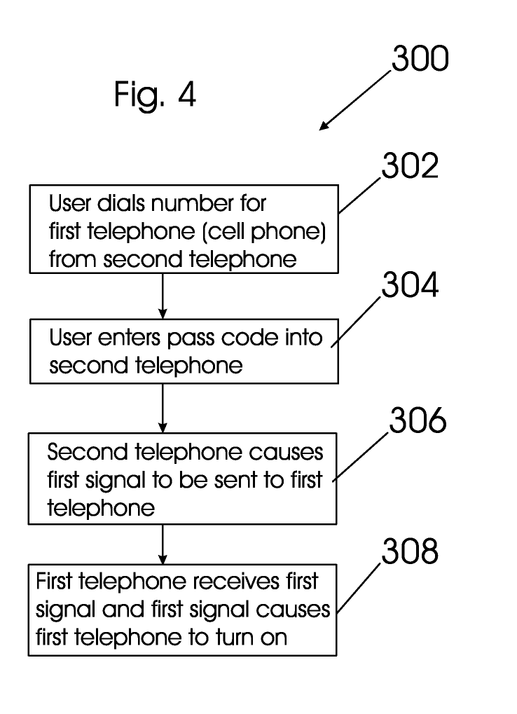

FIG. 4 shows a flow chart 300 of a method in accordance with an embodiment of the present invention. At step 302, a user uses a second telephone, such as second telephone 2 to dial a telephone number for a first telephone 6 (a cellular telephone). The user next enters a pass code into the second telephone 2 at step 4. The second telephone 2 causes a first or control signal to be sent from transmitter/receiver 4 to the first (cellular) telephone 6 if the pass code is acceptable, at step 6. At step 8, the first (cellular) telephone 6 receives the first or control signal and the first or control signal cause the first (cellular) telephone 6 to turn on or be activated so that it can receive telephone calls and will produce typically audible rings.

The first telephone 6 may receive the first or control signal via transmitter/receiver 206 and may supply the first or control signal to the processor 204. The processor 204 may be programmed to recognize the first or control signal and to execute a program in memory 202 to activate the first (cellular) telephone 6, so that when it receives a typical telephone call, the telephone 6 responds by ringing, i.e. producing an audible tone which is output from speaker 104. The first telephone 6 may be placed in an on/off state by pushing on/off switch 110 to place the telephone 6 in an on/off state. The switch 110 may be a toggle push button switch. The first telephone 6 may be placed in a silent or vibrate mode by pushing switch 112. The switch 112 may also be a toggle push button switch. The first or control signal sent by transmitter/receiver 4 may change the state of first telephone 6 from an off state (as set by switch 110) where the telephone 6 can't receive phone calls (other than responding to the first or control signal), to an on state where the telephone 6 can receive phone calls. The first or control signal sent by transmitter/receiver 4 may change the state of first telephone 6 from a silent or vibrate state (as set by switch 112) where the telephone 6 doesn't make any sounds in response to a phone call, to an audible state where the telephone 6 does make an audible sound in response to a phone call to telephone 6.

The first or control signal may or may not cause the telephone 6 to produce an immediate beeping noise or may just switch the state of telephone 6 from an off state to an on state or from a vibrate mode to an audible mode for phone calls to the telephone 6 after the first or control signal has influenced telephone 6. The first or control signal can be used to produce an immediate beeping noise so that the first (cellular) telephone 6 can be easily found.

The transmitter/receiver 4 and the transmitter/receiver 206 may each be a radio frequency transmitter/receiver. In an alternative embodiment, a processor, such as processor 204 of a particular cellular telephone, such as first telephone 6, can be programmed to block a first or control signal from changing the on/off state or the silent/audible state of the first telephone 6.

The first or control signal can also be used in one embodiment to change the state of the first (cellular) telephone 6 from a non-speaker mode to a speaker mode. This allows a user of the second telephone 2 to monitor the surroundings where the first (cellular telephone) 6 are located. For example, a parent can call a child's cellular phone, and turn on the speaker mode to be able to hear background noise more clearly, where the child is located.

In addition any of the remote features mentioned may be able to be disabled by entering an appropriate security code or codes into the first (cellular) telephone 6 into the keypad 106. The user of first (cellular) telephone 6 may also be able to enter a prompt or code so that the first (cellular) telephone 6 will flash a light as well as, or instead of beeping or ringing.

The first telephone 6 may include a battery not shown, for powering different components, such as memory 202, processor 204, interactive device 208, and transmitter/receiver 206. The interactive device 208 may include a ringer or beeper and may also include the display or monitor 102. The first telephone 6 may also include an auxiliary battery that can be utilized to provide power to the processor and any audio alerting mechanism, such as the speaker 104 of the cell phone 6, and such as a ringer or beeper. This will allow the person who is trying to locate his/her cell phone (i.e. the caller) to remotely cause the ringer/beeper or the speaker 104 in the telephone 6 to sound even though the main battery might be dead.

The processor 204 of the cellular telephone 6 may include global positioning system (GPS) tracking capabilities. The second telephone 2 of FIG. 1 can be used to turn on or off the GPS tracking capabilities of the cellular telephone 6. In one embodiment, when the GPS tracking capabilities are turned off, the cellular telephone 6 typically cannot be tracked using GPS.

The second telephone 2 may be a regular landline telephone or may be a remote cellular telephone. The second telephone 2 can be used to turn on a cellular phone, such as cellular telephone 6, which may have GPS capabilities.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising
a cellular telephone comprising
a device for placing the cellular telephone in an off state or an on state; wherein in the off state the cellular telephone cannot receive a telephone call, and in the on state the cellular telephone can receive a telephone call;
a processor; and
a receiver; and
wherein the processor is programmed to change the cellular telephone from the off state to the on state in response to a remote control signal received by the receiver.

2. An apparatus comprising
a cellular telephone comprising
a device for placing the cellular telephone in a silent state or an audible state; wherein in the silent state the cellular telephone responds to a telephone call with an alert that is not audible, and in the audible state the cellular telephone responds to a telephone call with an alert that is audible;
a processor; and
a receiver; and
wherein the processor is programmed to change the cellular telephone from the silent state to the audible state in response to a remote control signal received by the receiver.

3. The apparatus of claim 1
wherein processor is programmed to examine the remote control signal, such that the remote control signal must include a specific pass code in order for the processor to change the cellular telephone from the off state to the on state.

4. The apparatus of claim 2
wherein the processor is programmed to examiner the remote control signal, such that the remote control signal must include a specific pass code in order for the processor to change the cellular telephone from the silent state to the audible state.

5. A method comprising
receiving a remote control signal, including a pass code, at a first telephone, wherein the first telephone is a cellular telephone; and
causing the first telephone to change from an off state to an on state in response to the control signal if the pass code is determined to be acceptable.

6. The method of claim 5 further comprising
using a second telephone to dial a first telephone number of the first telephone;
using the second telephone to enter a representation of the pass code;
and sending out the remote control signal from the second telephone.

7. A method comprising
receiving a remote control signal, including a pass code, at a first telephone, wherein the first telephone is a cellular telephone; and
causing the first telephone to change from a silent state to an audible state in response to the control signal if the pass code is determined to be acceptable.

8. The method of claim 7 further comprising
using a second telephone to dial a first telephone number of the first telephone;
using the second telephone to enter a representation of the pass code;
and sending out the remote control signal from the second telephone.
